(19) United States
(12) Patent Application Publication
(10) Pub. No.: US 2025/0037004 A1
(43) Pub. Date: Jan. 30, 2025

(54) Confidential-Data Driven Profile Selection Using Artificial Intelligence

(71) Applicant: Capital One Services, LLC, McLean, VA (US)

(72) Inventor: Satyajit Sajanrao Nalavade, Mckinney, TX (US)

(21) Appl. No.: 18/225,727

(22) Filed: Jul. 25, 2023

(51) Int. Cl. G06N 20/00; G06N 5/04

(52) U.S. Cl. CPC G06N 20/00; G06N 5/04

(57) ABSTRACT

Aspects described herein may allow managing profiles using machine learning models. A computing device may train a case-based reasoning (CBR) machine learning model using customer data, sales agent data, and completed transaction data, to predict a likelihood of a successful transaction between a customer associated with a customer profile, and a sales agent associated with a sales agent profile. After receiving a first customer profile, the computing device may determine, based on the confidential information and by inputting the first customer profile and the plurality of sales agent profile into the CBR machine learning model, a first sales agent, of a plurality of sales agents, that has a high likelihood of making a successful transaction with the first customer. The computing device may send an excerpt of the first customer profile omitting the confidential information.

### FIELD OF USE

Aspects of the disclosure relate generally to data processing. More specifically, aspects of the disclosure may provide for systems and methods for selecting profiles using machine learning models.

### BACKGROUND

A bank may obtain data associated with a plurality of customers by receiving financial applications from the customers. The data of each individual customer, as well as the interrelationship between the data of different customers, may be helpful to customize services (e.g., to provide different services to different customers based on the preference of each customer). However, data may not be analyzed to facilitate service customization outside the bank, due to the confidentiality of the data. Systems and methods are needed to better utilize customer data for service customization without revealing confidential information.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Many service providers may benefit from data associated with their customers. For example, a service provider may customize the service it provides by determining the preferences of each customer based on customer data (e.g., customer's demographical information, financial information, and/or family information). For example, different customers may work well with different sales agents. With data associated with its customers, a car dealership may be able to select a sales agent who works well with a given customer. However, a service provider may not be able to obtain the customer data, especially if the customer data comprises sensitive and/or confidential information.

Other entities may be able to obtain the confidential information, but may not be able to provide the information to the service provider due to privacy restrictions. For example, a bank may be able to obtain a customer's financial information when the customer applies for a loan. However, due to privacy restrictions, the bank may not be able to share the customer's financial information with the car dealership. The customer data owned by the bank may be wasted and/or the service provider may not be able to customize its services.

To overcome limitations in the prior art described above, and to overcome other limitations that will be apparent upon reading and understanding the present specification, aspects described herein are directed towards selecting sales agents for a customer. The selection may be based on a customer profile that comprises both confidential information and non-confidential information about the customer. As described herein, a machine learning model may be trained to predict, among a plurality of sales agents, one or more sales agents each having a high likelihood of making a successful transaction with a given customer. The prediction may be based on comparing the customer profile with a plurality of sales agent profiles. Each of the plurality of sales agent profiles may comprise one or more attributes about the respective sales agent and/or a plurality of previously completed transactions made by the sales agent. The machine learning model may select the one or more sales agents if the one or more sales agents are experienced in making transactions with customers that are similar to the given customer, and/or if the sales agent profile has attributes that match the first customer profile. A recommendation of the selected sales agent(s) may be sent to a computing device associated with the dealership. The recommendation may be sent together with an excerpt of the given customer's profile. The excerpt may omit confidential information in the given customer's profile, even if the confidential information is used in the selection. Feedback regarding whether the selected sales agent(s) ended up making a transaction with the given customer may be provided. The feedback may be input into the machine learning model to further improve the accuracy of future predictions. In this way, confidential customer data may be utilized to customize services to the customer, without being disclosed to the service provider.

In at least some embodiments, a first computing device may train a case-based reasoning (CBR) machine learning model using customer data, sales agent data, and completed transaction data, to predict a likelihood of a successful transaction between: a customer associated with a customer profile, and a sales agent associated with a sales agent profile. The likelihood may be predicted based on comparing the customer profile to the sales agent profile. The first computing device may receive, from a first database, a first customer profile corresponding to a first customer, wherein the first customer profile comprises confidential information and nonconfidential information. The first computing device may receive, from a second computing device, a plurality of sales agent profiles each corresponding to a respective sales agent of a plurality of sales agents. The first computing device may determine, based on the confidential information by inputting the first customer profile and the plurality of sales agent profile into the CBR machine learning model, a first sales agent, of the plurality of sales agents, that has a high likelihood of making a successful transaction with the first customer. The first computing device may generate an excerpt of the first customer profile omitting the confidential information. The first computing device may send, to the second computing device, the excerpt, of the first customer profile, and an identification of the first sales agent. The first computing device may receive, from the second computing device, feedback indicating whether the first sales agent made the successful transaction with the first customer. The first computing device may store, in a second database, a mapping between the first customer profile and a first sales agent profile corresponding to the first sales agent. The first computing device may adjust, using the feedback, the confidential information in the first customer profile, and the mapping, the CBR machine learning model.

The first computing device may generate the excerpt of the first customer profile by generating, using auto-lead data format (ADF), the excerpt of the first customer profile.

The nonconfidential information of the first customer profile comprises at least one of: demographic information of the first customer; or one or more target transactions associated with the first customer. The confidential information of the first customer profile comprises financial information of the first customer. Each of the plurality of sales agent profiles comprises at least one of: a demographic attribute of the sales agent; or a sales expertise attribute of the sales agent.

The first computing device may determine the first sales agent that has the high likelihood of making a successful transaction with the first customer by using the CBR model to: weigh, based on a degree of match between the first customer profile and one or more attributes of the first sales agent profile, each of the one or more attributes; and determine, based on the weighing, a score indicating the high likelihood.

The first computing device may further receive, from the second database and for each of the plurality of sales agent profiles, one or more previously completed transactions made by the corresponding sales agent, and wherein the determining the first sales agent that has the high likelihood of making the successful transaction with the first customer may comprise using the CBR machine learning model to compare a similarity between the first customer profile and customer profiles associated with the one or more previously completed transactions.

Corresponding apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2A depicts an example computing environment in accordance with one or more illustrative aspects discussed herein;

FIG. 2B depicts an example deep neural network in accordance with one or more illustrative aspects discussed herein;

FIG. 3 is a flow diagram of an example method for profile selection in accordance with one or more illustrative aspects discussed herein;

FIG. 4A is a flow diagram of an example method for profile selection in accordance with one or more illustrative aspects discussed herein;

FIG. 4B is a flow diagram of an example method for profile selection in accordance with one or more illustrative aspects discussed herein.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

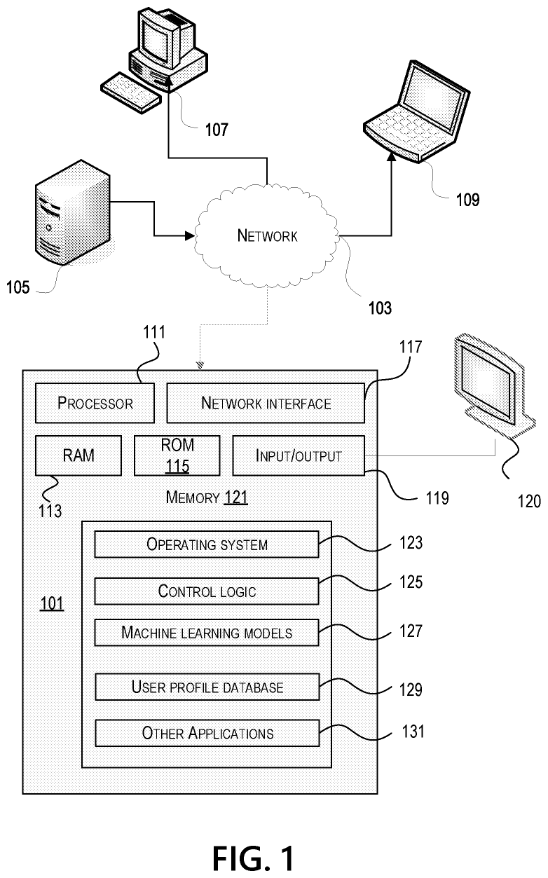

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading or executing instructions and performing one or more actions based on the instructions. In some embodiments, computing device 101 may represent, be incorporated in, or include various devices such as a desktop computer, a computer server, a mobile device (e.g., a laptop computer, a tablet computer, a smartphone, any other type of mobile computing devices, and the like), or any other type of data processing device.

Computing device 101 may, in some embodiments, operate in a standalone environment. In others, computing device 101 may operate in a networked environment. As shown in FIG. 1, various network nodes 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 109, and other devices (not shown) may be connected to one or more of the networks via twisted pair wires, coaxial cable, fiber optics, radio waves, or other communication media.

As seen in FIG. 1, computing device 101 may include a processor 111, RAM 113, ROM 115, network interface 117, input/output interfaces 119 (e.g., key board, mouse, display, printer, etc.), and memory 121. Processor 111 may include one or more computer processing units (CPUs), graphical processing units (GPUs), or other processing units such as a processor adapted to perform computations associating converting information, routing copies of messages, or other functions described herein. I/O 119 may include a variety of interface units and drives for reading, writing, displaying, or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling the overall operation of the computing device 101, control logic 125 for instructing computing device 101 to perform aspects discussed herein. Furthermore, memory 121 may store various databases and applications depending on the particular use, for example, machine learning models 127, user profile database 129, and other applications 131 may be stored in a memory of a computing device used at a server system that will be described further below. Control logic 125 may be incorporated in or may comprise a linking engine that updates, receives, or associates various information stored in the memory 121. In other embodiments, computing device 101 may include two or more of any or all of these components (e.g., two or more processors, two or more memories, etc.) or other components or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QOS), etc. For example, devices 101, 105, 107, 109, and others may operate in concert to provide parallel computing features in support of the operation of control logic 125.

One or more aspects discussed herein may be embodied in computer-usable or readable data or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer-executable instructions may be stored on a computer-readable medium such as a hard disk, optical disk, removable storage media, solid-state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field-programmable gate arrays (FPGA), and the like. Particular data structures may be used to more effectively implement one or more aspects discussed herein, and such data structures are contemplated within the scope of computer-executable instructions and computer-usable data described herein. Various aspects discussed herein may be embodied as a method, a computing device, a data processing system, or a computer program product.

The data transferred to and from various computing devices may include secure and sensitive data, such as confidential documents, customer personally identifiable information, and account data. Therefore, it may be desirable to protect transmissions of such data using secure network protocols and encryption, or to protect the integrity of the data when stored on the various computing devices. A file-based integration scheme or a service-based integration scheme may be utilized for transmitting data between the various computing devices. Data may be transmitted using various network communication protocols. Secure data transmission protocols or encryption may be used in file transfers to protect the integrity of the data such as, but not limited to, File Transfer Protocol (FTP), Secure File Transfer Protocol (SFTP), or Pretty Good Privacy (PGP) encryption. In many embodiments, one or more web services may be implemented within the various computing devices. Web services may be accessed by authorized external devices and customers to support input, extraction, and manipulation of data between the various computing devices. Web services built to support a personalized display system may be cross-domain or cross-platform, and may be built for enterprise use. Data may be transmitted using the Secure Sockets Layer (SSL) or Transport Layer Security (TLS) protocol to provide secure connections between the computing devices. Web services may be implemented using the WS-Security standard, providing for secure SOAP messages using XML encryption. Specialized hardware may be used to provide secure web services. Secure network appliances may include built-in features such as hardware-accelerated SSL and HTTPS, WS-Security, or firewalls. Such specialized hardware may be installed and configured in front of one or more computing devices such that any external devices may communicate directly with the specialized hardware.

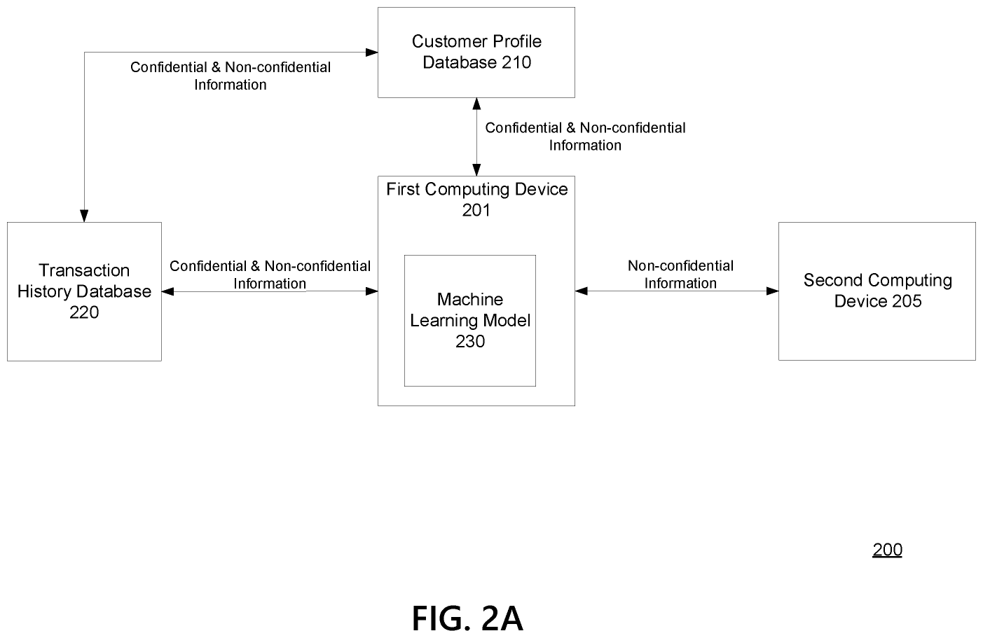

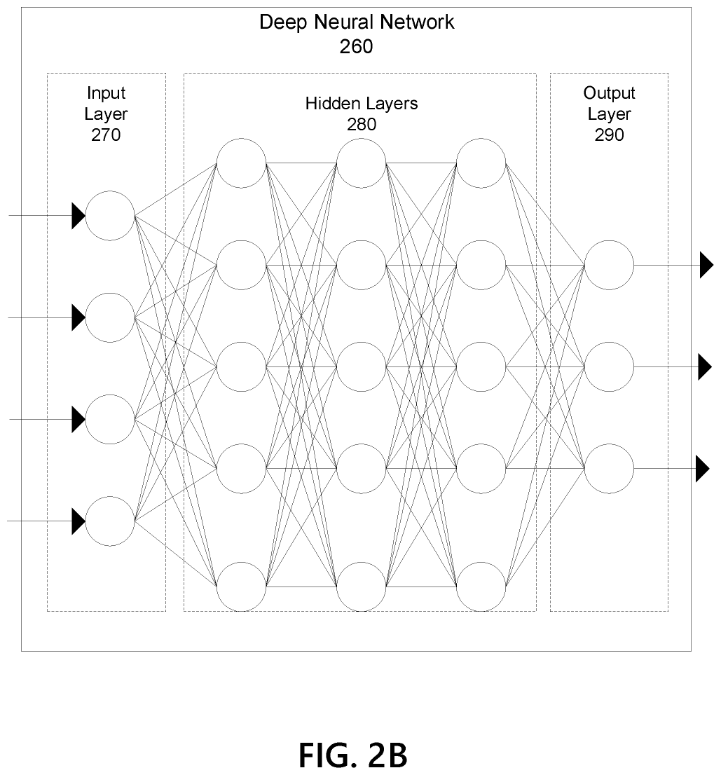

FIG. 2A depicts an illustrative computing environment for selecting profiles in accordance with one or more example embodiments. Referring to FIG. 2A, the computing environment 200 may include a first computing device 201, a second computing device 205, a customer profile database 210), a transaction history database 220, and/or a machine learning model 230. Each of the first computing device 201, the second computing device 205, the customer profile database 210, and the transaction history database 220 may be one or more computing devices 101 as described in FIG. 1. The first computing device 201, the second computing device 205, the customer profile database 210, and the transaction history database 220) may communicate with each other via network 103 as described in FIG. 1. The machine learning model 230) may be one or more machine learning models 260 as described in FIG. 2B. The machine learning model 230 may be executed on the first computing device 201, or may be executed on one or more computing devices (e.g., one or more computing devices 101 as described in FIG. 1) that are communicatively connected with the first computing device 201.

The first computing device 201 may be associated with an entity that serves a plurality of customers. The first computing device 201 may obtain data from the plurality of customers. For example, the entity may be a bank. The data (e.g., customer data) may be obtained while the back receives loan applications from the customers. For example, the first computing device 201 may be a server. The first computing device 201 may receive customer data from a plurality of client devices associated with the plurality of customers.

The second computing device 205 may be associated with a third party service provider. The third party service provider may provide services to a plurality of second customers. The second computing device 205 may obtain second customer data from the plurality of second customers. The plurality of customers of the entity associated with the first computing device 201 may overlap with the plurality of second customers. For example, the third party service provider may be a car dealership. Some of the overlapped customers may apply for an auto loan from the bank, and then purchase a car from the car dealer.

For a customer that provides information to both the bank and the car dealership, more information may be provided to the bank than to the dealership. For example, a customer may share the customer's name, contact information, and/or demographical information with both the bank and the car dealership. The customer may share other, potentially confidential, information only to the bank, not to the car dealership. For example, the confidential information may comprise financial information (e.g., assets and/or liabilities owned by the customer, annual income, rent, mortgage values, etc.), family information (e.g., whether the customer is married, how many kids the customer has, etc.), purchase histories (e.g., obtained by the bank whent the customer uses a bank card to make the purchase), medical information, advertisement interactions, or credit information. The customer data obtained by the first computing device 201 may be categorized as either non-confidential information or confidential information. Non-confidential information may comprise information to which both the first computing device 201 and the second computing device 205 have access. For example, a customer's name, contact information, and/or demographical information may be considered non-confidential. The car dealership may either obtain the information from the customers or the customers may authorize the bank to share the information with the car dealership. Confidential information may comprise information to which the first computing device 201 has access but the second computing device 205 does not have access. For example, a customer's financial information and/or family information may be considered confidential. The car dealership may not obtain the confidential information from the customer and/or the bank may not be authorized to share the confidential information with the car dealership. It is appreciated that what categories of information are confidential may vary in different situations, for example, based on the privacy agreement between the customer and the bank. The first computing device 201 may generate customer profiles based on information the first computing device 201 obtains from the customers. The customer profiles may be stored in a customer profile database 210.

The third party associated with the second computing device 205 may provide services to the customers. The service may be customized based on the preferences of each customer. For example, a car dealership may have a plurality of sales agents who help the customers to pick a car. Different customers may work well with different sales agents. A first sales agent that has a high likelihood to make a transaction with a first customer may have a low likelihood to make a transaction with a second customer. For example, a sales agent who speaks French may have a high likelihood to make a transaction with a French customer, but may have no advantages of dealing with a customer that speaks another language. In another example, a sales agent who is good at recommending economical cars may have a high likelihood to make a transaction with a customer who has a lower budget, but may not have the advantages of dealing with a customer who is willing to pay a high price for a luxury car. In order to provide better services, the car dealership may want to select a sales agent that fits a particular customer. However, the customer information the car dealership owns may not be enough to make the selection.

As described herein, a machine learning model 230 may be configured to select, among a plurality of sales agents, one or more sales agents that may have a high likelihood of making a successful transaction with a first customer. The machine learning model 230 may receive, from the first computing device 201, a first customer profile that comprises both the confidential information and non-confidential information of the first customer. The machine learning model 230 may receive, from the second computing device 205 (e.g., either directly or via the first computing device 201), a plurality of sales agent profiles. The likelihood of a successful transaction between a sales agent and the first customer may be predicted based on whether the sales agent completed transactions that involve customers similar to the first customer, and/or whether the sales agent profile has attributes that match the first customer profile. The machine learning model 230 may output the selection result to the first computing device 201. The first computing device 201 may send, to the second computing device 205, the identification of the selected sales agent(s) and the customer profile of the first customer. The first computing device 201 may omit confidential information of the first customer while communicating with the second computing device 205, so that confidential information may not be revealed to the second computing device 205.

As described herein, the machine learning model 230 may be further optimized by the feedback from the second computing device 205. The feedback may be received via the first computing device 201. The feedback may indicate which sales agent the first customer negotiated with, whether the negotiation developed into a successful transaction, and/or other relevant information associated with the negotiation and/or transaction. The feedback may be stored in a transaction history database 220. Data in the transaction history database 220 may be used to further train the machine learning model 230 to improve the accuracy of future predictions.

To ensure the security of the confidential information, the communication between the first computing device 201 and the databases (e.g., the customer profile database 210 and/or the transaction history database 220) may use one or more secure communication protocols, such as Transport Layer Security (TLS), Secure Socket Layer (SSL), Secure Shell (SSH), or any other suitable protocol that provides encryption and authentication services. Additional security measures may be implemented, including but not limited to database activity monitoring and/or data masking, to further enhance the protection of the confidential information stored in the databases.

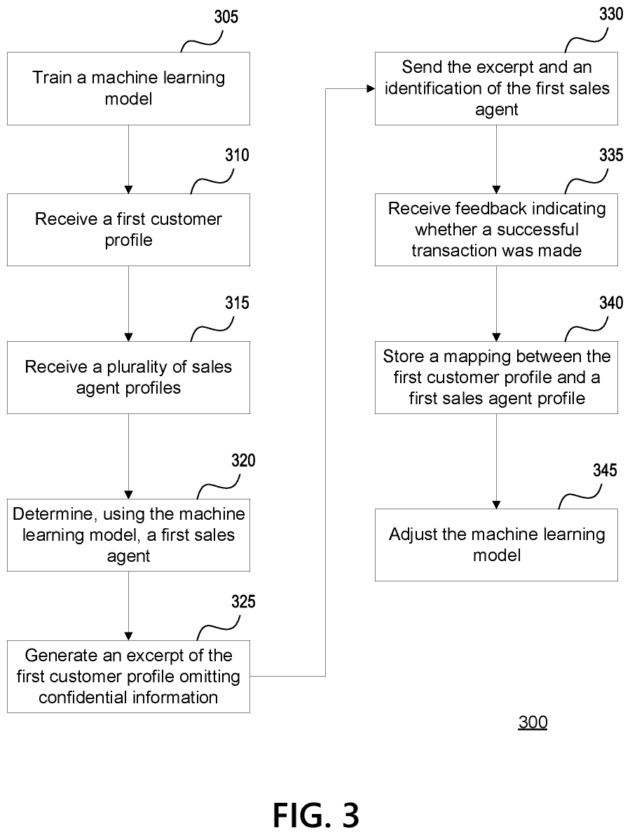

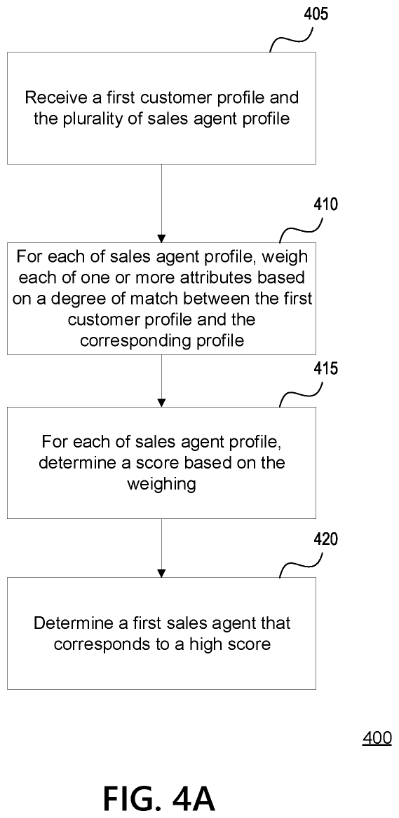

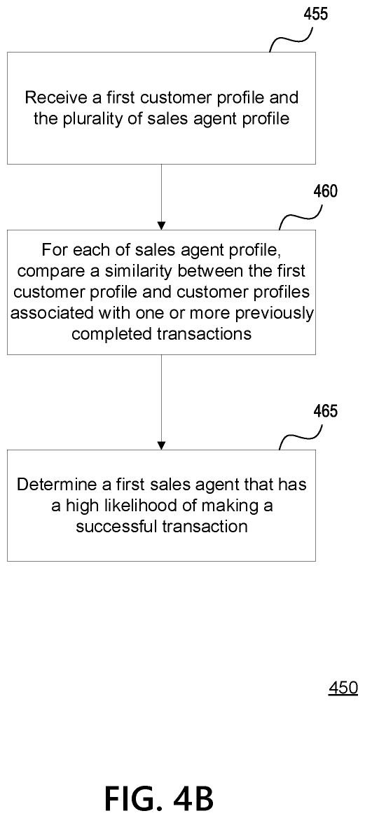

FIG. 2B illustrates an example deep neural network 260. Such a deep neural network architecture may be all or portions of the machine learning software 127 shown in FIG. 1. The deep neural network 260 may be all or portions of the machine learning model described in connection with FIG. 2A, FIG. 3 and FIG. 4. The architecture depicted in FIG. 2B need not be performed on a single computing device, and may be performed by, e.g., a plurality of computers (e.g., one or more of the devices 101, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 270, one or more hidden layers 280, and an output layer 290. A deep neural network, as used herein, may be an artificial network that has more than one hidden layer. Illustrated network architecture 260 is depicted with three hidden layers, and thus may be considered a deep neural network. The number of hidden layers employed in deep neural network 260 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

FIG. 3 is a flow diagram depicting method 300 for selecting profiles in accordance with one or more illustrative aspects discussed herein. The steps in method 300 may be performed by a system comprising, for example, the first computing device 201, the second computing device 205, and/or the machine learning model 230 as may be shown in FIG. 2A and/or FIG. 2B.

At step 305, a machine learning model 230 may be trained. The training may use training data including customer data, sales agent data, and/or completed transaction data. The training data may be obtained in real life or composed manually for training and/or testing purposes. The machine learning model 230 may be trained to select one or more sales agents, among a plurality of sales agents, that have a high likelihood of making a successful transaction with a given customer. The selection may be based on a prediction regarding a likelihood of a successful transaction between the given customer and each of the plurality of sales agents. A customer profile associated with the given customer, and/or a plurality of sales agent profiles associated with the plurality of sales agent profiles may be input into the machine learning model 230 to allow the machine learning model 230 to make the prediction.

For example, consistent with the example in FIG. 2A, the first computing device 201 may be a server associated with a bank. The customer data may be obtained while customers of the bank submit loan (e.g., auto loan) applications. The customer data may comprise information about the customer (e.g., the customer's demographic information, financial information, or any other information associated with the customer). The customer data may be stored in a database associated with the bank (e.g., the customer profile database 210). The bank may cooperate with a car dealership. The car dealership may have a plurality of sales agents. A customer who applies for an auto loan from the bank may go to the dealership to purchase a car. The dealership may provide, to the first computing device 201, a plurality of sales agent profiles corresponding to the plurality of sales agents. The machine learning model 230 may be trained to facilitate the dealership to select one or more sales agents that may have a high likelihood to make a successful transaction with the customer.

The machine learning model 230 may comprise a case-based reasoning (CBR) machine learning model. A CBR model may be a machine learning model that uses past experiences to solve new problems. A CBR model may operate by executing a sequence of processes including one, some, or all of case retrieval, case adaption, and/or case retention. As described herein and in greater detail below; to select one or more sales agents that have a high likelihood of making a transaction with a first customer, the CBR model may conduct case retrieval. The CBR model may retrieve, for each of the plurality of sales agent profiles, one or more previous transactions made by the given sales agent, and/or previous transactions made by sales agents who are similar to the given sales agent (e.g., sales agents whose profile has attribute values similar to the given sales agent profile). The previous transactions may be retrieved from a database (e.g., the transaction history database 220). In the case adaption process, the CBR model may select one or more sales agent. Each of the one or more sales agents may have completed previous transactions that involve a customer similar to the first customer. The machine learning model 239 may predict the selected sales agents each having a high likelihood of making a transaction with the first customer. In the case retention process, the CBR model may receive (e.g., via the first computing device 201) feedback regarding whether the sales agent(s) that the CBR model selected made a transaction with the first customer. The feedback may be stored in the database (e.g., the transaction history database 220) to improve future predictions. Alternatively or additionally, the machine learning model 230 may comprise a neural network as described in FIG. 2B. The neural network may adjust weights and thresholds based on each set of the training data and/or the feedback to improve the accuracy of future predictions.

At step 310, the first computing device 201 may receive, from a first database (e.g., the customer profile database 210), a first customer profile corresponding to a first customer. Consistent with the example above, the first customer may apply for an auto loan from a bank associated with the first computing device 201, and plan to go to the dealership associated with the second computing device 205 to purchase a car. For example, the first customer may make an appointment to meet a sales agent at the dealership. The second computing device 205 may receive the appointment information, which may comprise non-confidential information (e.g., name, contact information, target purchase, etc.) of the first customer. The second computing device 205 may send a request to the first computing device 201 to determine which one or more sales agent(s), of a plurality of sales agents, may have a high likelihood of making a transaction with the first customer. The second computing device 205 may send the request by calling an application programmable interface (API) of the first computing device. The first computing device 201 may retrieve the first customer profile based on the request from the second computing device 205.

The first customer profile may comprise confidential information and non-confidential information. As described above in connection with FIG. 2A, whether a piece of information is confidential or not may depend on whether the dealership has access to that information from a source independent from the bank, and/or whether the first customer authorizes the bank to share the information with the dealership. For example, the nonconfidential information of the first customer profile may comprise demographic information of the first customer (e.g., because the first customer may provide the demographic information to the dealership when purchasing the car). In another example, the nonconfidential information may comprise one or more target transactions (e.g., target type of the car, budget limits, etc.) associated with the first customer. For example, the confidential information of the first customer profile may comprise financial information and/or family information of the first customer.

At step 315, the first computing device 201 may receive, from a second computing device 205, a plurality of sales agent profiles each corresponding to a respective sales agent of a plurality of sales agents. Each of the plurality of sales agent profiles may comprise one or more attribute that describes the sales agent. For example, one of the attributes may be the demographic information of the sales agent. One of the attributes may be the sales expertise (e.g., types of car) of the sales agent. One of the attributes may be the personal hobbies (e.g., reading, hiking) of the sales agent. One of the attributes may be previous transactions made by the sales agent.

At step 320, the first computing device 201 may determine, one or more first sales agent(s), of the plurality of sales agents, that have a high likelihood of making a successful transaction with the first customer. The determination may be based on the non-confidential information and/or the confidential information in the first customer profile. The first computing device 201 may input the first customer profile and the plurality of the sales agent profiles into the machine learning model 230. The first computing device 201 may receive a recommendation from the machine learning model 230. The recommendation may comprise the first sales agent. The way that the machine learning model 230 determines the one or more first sales agents may be described in greater detail in connection with FIGS. 4A and/or 4B.

At step 325, the first computing device 201 may generate an excerpt of the first customer profile. The excerpt may omit the confidential information. The excerpt may facilitate the dealership to assign a sales agent to the first customer. The excerpt may comprise basic information about the first customer. The excerpt may be generated using a standard format readable to the second computing device 205. For example, the excerpt may be in an Extensible Markup Language (XML) format. In the example where the dealership is an automobile dealership, the excerpt may be in a format of auto-lead data format (ADF). The ADF excerpt may comprise the first customer's contact information, the vehicle that the first customer is interested in, the type of inquiry (e.g., purchase, lease, or finance), and any additional comments. The ADF may facilitate various customer relationship management (CRM) systems of the dealership to process the excerpt.

At step 330, the first computing device 201 may send, to the second computing device 205, the excerpt. The first computing device 201 may also send an identification of one or more sales agents that the machine learning model 230 predict to have a high likelihood to make a successful transaction with the first customer. If more than one sales agents are selected, the first computing device 201 may send a ranking for the one or more sales agents. For example, a higher ranking may be associated with a higher likelihood of a sucessful transaction. The first computing device 201 may send the excerpt and/or the identification of the one or more sales agent by calling an API on the second computing device 205.

At step 335, the first computing device 201 may receive, from the second computing device 205, feedback indicating whether the first sales agent made the successful transaction with the first customer and/or information of the transaction. For example, if the first customer purchased a car from the first sales agent, the feedback may indicate the time the purchase was made, the type of vehicle that the first customer purchased, and/or the satisfaction level of the first customer. If the first customer did not purchase a car from the first sales agent, the feedback may indicate whether the first sales agent negotiated with the first customer, the first customer's comments on the experience with the first sales agent, and/or the first customer's comments on the reason why no vehicle was purchased from the first sales agent.

At step 340, the first computing device 201 may store, in a second database (e.g., the transaction history database 220), a mapping between the first customer profile and a first sales agent profile corresponding to the first sales agent. The mapping may comprise the feedback. The mapping may be linked to the first customer profile that comprises confidential information of the first customer.

At step 345, the machine learning model 230 may be adjust, using the feedback, the confidential information in the first customer profile, and/or the mapping. The machine learning model 230 may adjust the parameters (e.g., as described in connection with FIG. 2B) based on the feedback. The feedback may be used during a reinforcement learning process. For example, a successful transaction may be treated as positive feedback (e.g., a reward). No transaction between the first customer and the first sales agent may be treated as negative feedback (e.g., a penalty). In the example where the first customer's comments are included in the feedback, the comments may also be used by the machine learning model 230. For example, a successful transaction that the customer had a higher satisfaction level may be given a higher weight (as strong positive feedback) than a successful transaction that the customer had a lower satisfaction level. In another example, an unsuccessful transaction (e.g., no purchase was made) due to the first customer's bad purchasing experience may be given a higher weight (as strong negative feedback) than an unsuccessful transaction due to the customer's personal reason (e.g., the customer faced a financial crisis before purchasing a car). In the example where the machine learning model 230 comprises a CBR model, the mapping and/or the feedback may also be retained for future predictions, for example, during the case retention process as described in step 305.

The steps of method 300 may be modified, omitted, or performed in other orders, or other steps added as appropriate.

FIG. 4A is a flow diagram depicting method 400 for selecting profiles in accordance with one or more illustrative aspects discussed herein. The steps in method 400 may be performed by a system comprising, for example, the first computing device 201 and/or the machine learning model 230, as may be shown in FIG. 2A and/or FIG. 2B. The Method 400 in FIG. 4A may be used in connection with FIG. 3. For example, method 400 may be used to determine a first sales agent, of the plurality of sales agents, that has a high likelihood of making a successful transaction with the first customer, as described in FIG. 3. The method 400 may be used additionally or alternatively to the method 450 as described in FIG. 4B.

At step 405, the machine learning model 230 may receive a first customer profile and a plurality of sales agent profiles. For example, the first customer profile may be the first customer profile described in connection with FIG. 3. The plurality of sales agent profiles may be the plurality of sales agent profiles described in connection with FIG. 3. The first computing device 201 may input the first customer profile and the plurality of sales agent profiles into the machine learning model 230, as described in step 320. The machine learning model 230 may be trained in a way similar to described in FIG. 3.

At step 410, the machine learning model 230 may operate on each of the plurality of sales agent profiles. For each of the plurality of sales agent profiles, the machine learning model 230 may identify one or more attribute categories and/or one or more attribute values for each identified attribute category. For example, a first attribute category may be languages that the sales agent speaks. A first attribute value of the first attribute category may indicate the sales agent speaks both English and French. A second attribute category may be the sales expertise (e.g., types of car) of the sales agent. A second attribute value may indicate the expertise of the sales agent is to sell luxury cars. A third attribute category may be the personal hobbies of the sales agent. A third attribute value may indicate the sales agent's hobby is reading. A fourth attribute category may be previous transactions made by the sales agent. A fourth attribute value may indicate (e.g., by an address to a database) previous transactions made by the sales agent.

The one or more attributes may be described by natural language (e.g., an introduction of the sales agent). The machine learning model 230 may identify one or more attributes using language recognition techniques. Additionally or alternatively, one or more attributes may be described by a code (e.g., 01 represents the sales agent speaks English) that is otherwise readable by the machine learning model 230.

The machine learning model 230 may weigh each of the one or more attributes. The weighing of each attribute may be based on a category of the attribute and a degree of match between the first customer profile and a value of the attribute.

Different attribute categories may be assigned different category weights (e.g., a coefficient number). The category weight may be based on an estimation of whether a match between the first customer profile and a value of the respective attribute in the sales agent profile is important for a successful transaction or not. For example, a match between the expertise of the sales agent and the target purchase of the first customer may be estimated as very important to a successful transaction. The expertise attribute may be assigned a high category weight (e.g., 10). A match between the primary language the sales agent speaks and the primary language the first customer speaks may be estimated as moderately important to a successful transaction. The language attribute may be assigned a middle category weight (e.g., 5). A match between the sales agent's hobby and the first customer's hobby may be estimated as not quite important to a successful transaction. The hobby attribute may be assigned a low category weight (e.g., 2).

For each attribute category, a matching weight may be assigned based on the degree of match between the first customer profile and a value of the attribute in the sales agent profile. For example, the matching weight may be determined based on a similarity between a value in the first customer profile and a value of the attribute in the sales agent profile. A higher matching weight may be assigned to a higher degree of similarity. For example, a first attribute may be the sales agent's expertise. A first attribute value may indicate the sales agent's expertise is luxury sport utility vehicles (SUVs). If the first customer profile indicates the first customer's target purchase is luxury SUVs, a high weight (e.g., 10) may be assigned. If the first customer profile indicates the first customer's target purchase is luxury vehicles in general but not necessarily SUVs, an intermediate weight (e.g., 5) may be assigned. If the first customer profile indicates the first customer's target purchase is economical compact vehicles, a low weight (e.g., 0) may be assigned. For example, a second attribute may be the language the sales agent speaks. The first customer profile may indicate the primary language of the first customer. If the primary language of the first customer is the sales agent's primary language, a high weight (e.g., 10) may be assigned. If the sales agent is able to speak the primary language of the first customer fluently but the primary language of the first customer was not a native language to the sales agent, an intermediate weight (e.g., 8) may be assigned. If the sales agent is able to speak a few words of the primary language of the first customer, a lower weight (e.g., 2) may be assigned. If the sales agent does not speak the primary language of the first customer at all, no weight (e.g., 0) may be assigned.

Additionally or alternatively to a similarity between the first customer's profile and the sales agent profile, the degree of matching may be based on other relations between a value in the first customer's profile and an value of the attribute in the sales agent profile. For example, a higher matching weight may be assigned if, when the value in the first customer's profile and the value in the sales agent profile appear together, a high likelihood of a successful transaction occurs. For example, a high likelihood of a successful transaction may occur if the first customer and the sales agent are of opposite genders. In such a scenario, a higher matching weight may be assigned based on the first customer and the sales agent being the opposite genders.

Confidential information may be used when determining a degree of matching. For example, financial information and/or family information may be used to evaluate a match between the sales agent's expertise and the first customer's target purchase. For example, the first customer may have stated that the first customer was targeted at purchasing a compact vehicle, but the first customer may have a large family with many kids. A sales agent whose expertise is selling SUVs may receive a higher matching weight (e.g., a weight higher than if the stated target purchase was used without the family information). This may because the first customer may deviate from the first customer's original target purchase (the compact vehicle) and end up purchasing an SUV so that all the family members may be fit into the same car. In another example, the first customer may have stated that the first customer's target purchase was a luxury car but the first customer's financial budget may be limited. A sales agent whose expertise is selling economical vehicles may receive a higher matching weight (e.g., a weight higher than if the stated target purchase was used without the financial information). This may be because the first customer may deviate from the first customer's original target purchase (the luxury vehicle) and end up purchasing an economical car to reduce the financial burden.

The weight of each attribute in a sales agent profile may be the matching weight multiple of the category weight. For example, the first attribute associated with the expertise of a sales agent may be assigned a category weight of 10. A matching weight of 5. The weight of the first attribute may be 10 multiplied by 5, which equals 50.

Initially, the weights (e.g., category weights and/or matching weights) may be randomly assigned or the weights may be assigned manually by an administrator of the machine learning model 230. Training data (e.g., as described in step 305 of FIG. 3) and/or feedback (e.g., as described in steps 335-345) may be input into the machine learning model 230. The machine learning model 230 may adjust the weights based on the training data and/or feedback to improve the accuracy of the predictions. For example, initially, a match between the sales agent's hobby and the first customer's hobby may be considered as not important and therefore may be assigned a low weight (e.g., 2). As more training data and/or feedback data that indicates a stronger correlation between a successful transaction and a match in hobbies between the sales agent and the customer, the machine learning model 230 may adjust the category weight based on the stronger correlation. For example, the machine learning model 230 may increase the category weight from 2 to 6. In another example, the machine learning model 230 may initially determine the matching weight between a sales agent's expertise and the first customer's target purchase based on the first customer's stated target purchase (without taking the financial information into account). As more training data and/or feedback data that indicates a deviation, of the first customer's target purchase from the first customer's actual purchase, may be associated with the first customer's financial information, the machine learning model 230 may adjust the matching weight based on the deviation.

It is appreciated that the attributes, the weights, and the way to determine the degree of match are merely examples, other attributes, weights, and/or ways to determine the degree of match are possible.

At step 415, the machine learning model 230 may, for each of the plurality of sales agent profiles, determine an overall score. The overall score may be based on a likelihood of a successful transaction between the first customer, associated with the first customer profile, and a sales agent associated with the respective sales agent profile. The overall score may be based on the weighing. For example, the overall score of a sales agent profile may be a sum of the weights of each attribute in the sales agent profile. For example, if the first sales agent profile indicates two attributes—a first attribute (e.g., expertise attribute) is assigned a score of 50, and a second attribute (e.g., language attribute) is assigned a score of 30—the overall score may be 50 plus 30, which equals 80.

A higher score may indicate a higher likelihood of a successful transaction between the first customer and a respective sales agent. A threshold (e.g., an overall score of 50) may be determined. For example, the machine learning model 230 may determine that a sales agent has a high likelihood of a successful transaction with the first customer if the overall score of the sales agent's profile receives is equal to or higher than the threshold.

At step 420, the machine learning model 230 may determine one or more sales agent profiles (e.g., a first sales agent profile) that correspond to a high score. The machine learning model 230 may output the result of the determination. For example, the determination may be used by the first computing device 201 at step 320 in FIG. 3. As may be described in greater detail in FIG. 3, the first computing device 201 may output an excerpt of the first customer together with a recommendation of the one or more selected sales agents. The excerpt may omit the confidential information even if the confidential information may be used by the machine learning model 230 for the recommendation.

The steps of method 400 may be modified, omitted, or performed in other orders, or other steps added as appropriate.

FIG. 4B is a flow diagram depicting method 450 for selecting profiles in accordance with one or more illustrative aspects discussed herein. The steps in method 450 may be performed by a system comprising, for example, the first computing device 201 and/or the machine learning model 230 as may be shown in FIG. 2A and/or FIG. 2B. The Method 450 in FIG. 4B may be used in connection with FIG. 3. For example, method 450 may be used to determine a first sales agent, of the plurality of sales agents, that has a high likelihood of making a successful transaction with the first customer, as described in FIG. 3. The method 450 may be used additionally or alternatively to the method 400.

At step 455, the machine learning model 230 may receive a first customer profile and a plurality of sales agent profiles. For example, the first customer profile may be the first customer profile described in connection with FIG. 3. The plurality of sales agent profiles may be the plurality of sales agent profiles described in connection with FIG. 3. Each of the plurality of sales agent profiles may comprise one or more previously completed transactions made by the corresponding sales agent. The one or more previously completed transactions made by the corresponding sales agent may be received from a second database (e.g., the transaction history database 220 as shown in FIG. 2A).

The second database may store information associated with previously completed transactions. The information may comprise basic transaction information such as the transaction time, the object purchased in the transaction, and/or the price of the object. The information may comprise the customer profile corresponding to a customer in the transaction. The customer profile may include confidential information and/or non-confidential information, as may be described in connection with FIG. 3.

At step 460, the machine learning model 230 may operate on each of the plurality of sales agent profiles. For each of the plurality of sales agent profiles, the machine learning model 230 may compare the similarity between the first customer profile and customer profiles associated with one or more previously completed transactions made by the respective sales agent.

For example, a first sales agent profile may indicate a first sales agent made a plurality of transactions in the past. Each of the plurality of transactions may be associated with a respective customer profile. The machine learning model 230 may compare a similarity between the first customer profile with each of the customer profiles associated with the plurality of transactions that the first sales agent made in the past. A similarity score indicating the similarity between the first customer profile and each of the customer profiles in past transactions may be calculated. A similarity score between two customer profiles may be based on the degree of similarity between one or more attributes in the two customer profiles. Some of the attributes may relate to non-confidential information (e.g., languages the respective customer speaks, demographical information, target purchases, personal hobbies, etc.) as described herein. Some of the attributes may relate to confidential information (e.g., financial information, family information, etc.) as described herein. The similarity score may be calculated based on one or more distance measurement algorithms (e.g., Euclidean distance algorithm, Manhattan distance algorithm, Minkowsik distance algorithm, Hamming distance algorithm, etc.). The similarity score may be calculated based on a nearest neighbor algorithm. Previous transactions made by the sales agent that has a similarity score higher than a threshold may be identified.

At step 465, the machine learning model 230 may determine a first sales agent profile that has a high likelihood of making a successful transaction with the first customer, based on a higher degree of similarity between the first customer profile and customer profiles associated with past transactions made by the first sales agent. For example, the machine learning model 230 may calculate an overall score for each sales agent. The overall score of a sales agent may be calculated based on the similarity scores between the first customer profile and each of the customer profiles associated with past transactions made by the sales agent. A higher overall score may indicate the sales agent made a larger quantity of previous transactions with customers that are similar to the first customer, and/or if a sales agent made a higher percentage of previous transactions with customers that are similar to the first customer. For example, the overall score may be based on the quantity of the previous transactions identified at step 460 for the sales agent. In another example, the overall score may be based on a ratio of the previous transactions identified at step 460 in relation to a total quantity of previous transactions made by the sales agent. The machine learning model 230 may determine the first sales agent's overall score is higher than a threshold. The machine learning model 230 may output the result of the determination. For example, the determination may be used by the first computing device 201 at step 320 in FIG. 3.

The steps of method 450 may be modified, omitted, or performed in other orders, or other steps added as appropriate. For example, method 450 may be used in combination with method 400 to select one or more sales agents that have a high likelihood of making a successful transaction with the first customer.

For example, a machine learning model 230 may comprise a first machine learning model, a second machine learning model, and/or a third machine learning model. The first machine learning model may determine a score based on steps in method 450. The second machine learning model may determine a score based on steps in method 400. The third machine learning model may combine the results from the first machine learning model and the second machine learning model (e.g. by assigning a weight to the result from each of the first machine learning model and the second machine learning model) to make an ultimate determination.

Although the subject matter has been described in language specific to structural features or methodological acts, it is to be understood that the subject matter defined in the appended claims is not necessarily limited to the specific features or acts described above. Rather, the specific features and acts described above are disclosed as example forms of implementing the claims. Accordingly, the scope of the invention should be determined not by the embodiments illustrated, but by the appended claims and their equivalents.

What is claimed is:

1. A method comprising:
training a case-based reasoning (CBR) machine learning model using customer data, sales agent data, and completed transaction data, to predict a likelihood of a successful transaction between:
a customer associated with a customer profile, and
a sales agent associated with a sales agent profile,
wherein the likelihood is predicted based on comparing the customer profile to the sales agent profile;
receiving, by a first computing device from a first database, a first customer profile corresponding to a first customer, wherein the first customer profile comprises confidential information and nonconfidential information;
receiving, by the first computing device from a second computing device, a plurality of sales agent profiles each corresponding to a respective sales agent of a plurality of sales agents;
determining, based on the confidential information by inputting the first customer profile and the plurality of sales agent profile into the CBR machine learning model, a first sales agent, of the plurality of sales agents, that has a high likelihood of making a successful transaction with the first customer;
generating an excerpt of the first customer profile omitting the confidential information;
sending, by the first computing device and to the second computing device, the excerpt, of the first customer profile, and an identification of the first sales agent;
receiving, from the second computing device, feedback indicating whether the first sales agent made the successful transaction with the first customer; and
storing, in a second database, a mapping between the first customer profile and a first sales agent profile corresponding to the first sales agent; and
adjusting, using the feedback, the confidential information in the first customer profile, and the mapping, the CBR machine learning model.

2. The method of claim 1, wherein the generating the excerpt of the first customer profile comprises generating, using auto-lead data format (ADF), the excerpt of the first customer profile.

3. The method of claim 1, wherein the nonconfidential information of the first customer profile comprises at least one of:
demographic information of the first customer; or
one or more target transactions associated with the first customer.

4. The method of claim 1, wherein the confidential information of the first customer profile comprises financial information of the first customer.

5. The method of claim 1, wherein each of the plurality of sales agent profiles comprises at least one of:
a demographic attribute of the sales agent; or
a sales expertise attribute of the sales agent.

6. The method of claim 1, wherein the determining the first sales agent that has the high likelihood of making the successful transaction with the first customer comprises using the CBR model to:
weigh, based on a degree of match between the first customer profile and one or more attributes of the first sales agent profile, each of the one or more attributes; and
determine, based on the weighing, a score indicating the high likelihood.

7. The method of claim 1, further comprising receiving, from the second database and for each of the plurality of sales agent profiles, one or more previously completed transactions made by the corresponding sales agent, and
wherein the determining the first sales agent that has the high likelihood of making the successful transaction with the first customer comprises using the CBR machine learning model to compare a similarity between the first customer profile and customer profiles associated with the one or more previously completed transactions.

8. A system comprising:
a first computing device; and
a second computing device;
wherein the first computing device is configured to:
train a case-based reasoning (CBR) machine learning model using customer data, sales agent data, and completed transaction data, to predict a likelihood of a successful transaction between:
a customer associated with a customer profile, and
a sales agent associated with a sales agent profile,
wherein the likelihood is predicted based on comparing the customer profile to the sales agent profile;
receive, from a first database, a first customer profile corresponding to a first customer, wherein the first customer profile comprises confidential information and nonconfidential information;
receive, from a second computing device, a plurality of sales agent profiles each corresponding to a respective sales agent of a plurality of sales agents;
determine, based on the confidential information by inputting the first customer profile and the plurality of sales agent profile into the CBR machine learning model, a first sales agent, of the plurality of sales agents, that has a high likelihood of making a successful transaction with the first customer;
generate an excerpt of the first customer profile omitting the confidential information;
send, to the second computing device, the excerpt, of the first customer profile, and an identification of the first sales agent;
receive, from the second computing device, feedback indicating whether the first sales agent made the successful transaction with the first customer; and
store, in a second database, a mapping between the first customer profile and a first sales agent profile corresponding to the first sales agent; and
adjust, using the feedback, the confidential information in the first customer profile, and the mapping, the CBR machine learning model.
wherein the second computing device is configured to:
receive, from the first computing device, the excerpt.

9. The system of claim 8, wherein the first computing device is configured to generate the excerpt of the first customer profile by generating, using auto-lead data format (ADF), the excerpt of the first customer profile.

10. The system of claim 8, wherein the nonconfidential information of the first customer profile comprises at least one of:
demographic information of the first customer; or
one or more target transactions associated with the first customer.

11. The system of claim 8, wherein the confidential information of the first customer profile comprises financial information of the first customer.

12. The system of claim 8, wherein each of the plurality of sales agent profiles comprises at least one of:
a demographic attribute of the sales agent; or
a sales expertise attribute of the sales agent.

13. The system of claim 8, wherein the first computing device is configured to determine the first sales agent that has the high likelihood of making the successful transaction with the first customer by using the CBR model to:
weigh, based on a degree of match between the first customer profile and one or more attributes of the first sales agent profile, each of the one or more attributes; and
determine, based on the weighing, a score indicating the high likelihood.

14. The system of claim 8, wherein the first computing device is further configured to:
receive, from the second database and for each of the plurality of sales agent profiles, one or more previously completed transactions made by the corresponding sales agent; and
determine the first sales agent that has the high likelihood of making the successful transaction with the first customer by using the CBR machine learning model to compare a similarity between the first customer profile and customer profiles associated with the one or more previously completed transactions.

15. A non-transitory computer-readable medium storing computer instructions that, when executed by one or more processors, cause performance of actions comprising:
training a case-based reasoning (CBR) machine learning model using customer data, sales agent data, and completed transaction data, to predict a likelihood of a successful transaction between:
a customer associated with a customer profile, and
a sales agent associated with a sales agent profile,
wherein the likelihood is predicted based on comparing the customer profile to the sales agent profile;
receiving, by a first computing device from a first database, a first customer profile corresponding to a first customer, wherein the first customer profile comprises confidential information and nonconfidential information;
receiving, by the first computing device from a second computing device, a plurality of sales agent profiles each corresponding to a respective sales agent of a plurality of sales agents;
receiving, for each of the plurality of sales agent profiles, one or more previously completed transactions made by the corresponding sales agent;
determining, based on the confidential information by inputting the first customer profile and the plurality of sales agent profile into the CBR machine learning model, a first sales agent, of the plurality of sales agents, that has a high likelihood of making a successful transaction with the first customer, wherein the first sales agent is determined based on a similarity between the first customer profile and the one or more previously completed transactions made by the first sales agent;
generating an excerpt of the first customer profile omitting the confidential information;
sending, by the first computing device and to the second computing device, the excerpt, of the first customer profile, and an identification of the first sales agent;
receiving, from the second computing device, feedback indicating whether the first sales agent made the successful transaction with the first customer; and
storing, in a second database, a mapping between the first customer profile and a first sales agent profile corresponding to the first sales agent; and
adjusting, using the feedback, the confidential information in the first customer profile, and the mapping, the CBR machine learning model.

16. The non-transitory computer-readable medium of claim 15, wherein the instructions, when executed, cause the one or more processors to generate the excerpt of the first customer profile by generating, using auto-lead data format (ADF), the excerpt of the first customer profile.

17. The non-transitory computer-readable medium of claim 15, wherein the nonconfidential information of the first customer profile comprises at least one of:
demographic information of the first customer; or
one or more target transactions associated with the first customer.

18. The non-transitory computer-readable medium of claim 15, wherein the confidential information of the first customer profile comprises financial information of the first customer.

19. The non-transitory computer-readable medium of claim 15, wherein each of the plurality of sales agent profiles comprises at least one of:
a demographic attribute of the sales agent; or
a sales expertise attribute of the sales agent.

20. The non-transitory computer-readable medium of claim 15, wherein the instructions, when executed, cause the one or more processors to determine the first sales agent that has the high likelihood of making the successful transaction with the first customer by using the CBR model to:
weigh, based on a degree of match between the first customer profile and one or more attributes of the first sales agent profile, each of the one or more attributes; and
determine, based on the weighing, a score indicating the high likelihood.
